(19) United States
(12) Patent Application Publication
(10) Pub. No.: US 2026/0280426 A1
(43) Pub. Date: Sep. 17, 2026

(54) DUAL OUTPUT BUCK DC/DC CONVERTER

(71) Applicant: Raytheon Company, Arlington, VA (US)

(72) Inventors: John R. Stowell, Sahuarita, AZ (US); Del Eric Stroud, Oro Valley, AZ (US); Chris Kavourinos, Tucson, AZ (US); Alden Alviar, Tucson, AZ (US)

(21) Appl. No.: 19/077,567

(22) Filed: Mar. 12, 2025

(51) Int. Cl. H02M 3/158; H02M 1/00

(52) U.S. Cl. CPC H02M 3/158; H02M 1/009

(57) ABSTRACT

A dual output buck DC-to-DC converter includes a positive voltage rail that receives a positive DC voltage from a DC power source, a negative voltage rail that receives a negative DC voltage from the DC power source, a switch connected between the positive voltage rail and a switching node, and a pulsed DC voltage source that delivers a PWM signal to the switch. A positive voltage output circuit is connected across the switching node and the negative voltage rail to conduct current from the positive voltage rail in a first direction to generate a positive output voltage in response to the switch operating in conducting state. A negative voltage output circuit is connected across the switching node and the negative voltage rail to conduct current from the negative voltage rail in a second direction to generate a negative output voltage in response to the switch operating in a non-conductive state.

### BACKGROUND

The present disclosure relates to direct current (DC) to direct current (DC) power converters, and more specifically to a dual output DC to DC buck converter topology.

Electrically driven components, such as sensors, can require DC power sources in order to operate. Such components are referred to as DC components. In some cases, when a DC voltage is provided, the power is converted into a different DC form using a power converter. Typical DC to DC power converters receive power and provide a different DC voltage rail with respect to a return node. The different DC voltage may include a DC output voltage having a different voltage level (e.g., a higher positive output voltage or a lower positive output voltage) with respect to the input voltage. In other application, the different DC voltage may include a DC output voltage having a different voltage polarity (e.g., a negative voltage) compared to the input voltage (e.g., a positive voltage).

### SUMMARY

According to a non-limiting embodiment, a dual output buck direct current-to-direct current (DC/DC) converter comprises a positive voltage rail configured to receive a positive DC voltage from a DC power source, and a negative voltage rail configured to receive a negative DC voltage from the DC power source. A switch includes a PWM input connected to the positive voltage rail and a PWM output connected to a switching node. A pulsed DC voltage source is configured to deliver a PWM signal to the switch. A positive voltage output circuit is connected across the switching node and the negative voltage rail. The positive voltage output circuit is configured to conduct current from the positive voltage rail in a first direction to generate a positive output voltage in response to the switch operating in conducting state. A negative voltage output circuit is connected across the switching node and the negative voltage rail. The negative voltage output circuit is configured to conduct current from the negative voltage rail in a second direction to generate a negative output voltage in response to the switch operating in a non-conductive state.

In addition to one or more of the features described above, or as an alternative to any of the foregoing embodiments, a voltage clipper circuit is connected across the switching node and the negative voltage rail.

In addition to one or more of the features described above, or as an alternative to any of the foregoing embodiments, the voltage clipper circuit comprises: a first diode having an anode connected to the negative voltage rail; and a voltage clamping device including a first terminal connected to a cathode of the first diode, and including an opposing second terminal connected to the switching node.

In addition to one or more of the features described above, or as an alternative to any of the foregoing embodiments, the voltage clamping device includes a Zener diode having a cathode connected to a cathode of the first diode and having an anode connected to the switching node.

In addition to one or more of the features described above, or as an alternative to any of the foregoing embodiments, the negative voltage output circuit comprises: a first capacitor having a first terminal connected to the negative voltage rail; a second diode having an anode connected to an opposing second terminal of the first capacitor, and having a cathode connected to the switching node; and a negative voltage load having a first terminal connected to the negative voltage rail and an opposing second terminal connected in common with the second terminal of the first capacitor and the anode of the second diode to establish a negative voltage node configured to deliver the negative output voltage.

In addition to one or more of the features described above, or as an alternative to any of the foregoing embodiments, the positive voltage output circuit comprises: an inductor having a first terminal electrically connected to the switching node; a second capacitor having a first terminal connected to an opposing second terminal of the inductor to establish a positive voltage node, and having an opposing second terminal connected to the negative voltage rail; and a positive voltage load having a first terminal connected to the positive voltage node and an opposing second terminal connected to the negative voltage rail, wherein the positive voltage node is configured to deliver the positive output voltage.

In addition to one or more of the features described above, or as an alternative to any of the foregoing embodiments, the PWM circuit comprises: the switch connected between the positive voltage rail and the switching node; and the pulsed DC voltage source including a negative output connected the switching node to deliver the negative voltage pulses, and a positive output connected to the switch to deliver positive voltage pulses that control a switching state of the switch.

In addition to one or more of the features described above, or as an alternative to any of the foregoing embodiments, the switch includes a metal oxide semiconductor field effect transistor (MOSFET) comprising: a drain serving as the PWM input connected to the positive voltage rail; a gate connected to the positive output of the pulsed DC voltage source; and a source serving as the PWM output connected to the switching node.

In addition to one or more of the features described above, or as an alternative to any of the foregoing embodiments, the negative output voltage is generated during a passive duty cycle of the dual output buck DC/DC converter, and the positive output voltage is generated during an active duty cycle of the dual output buck DC/DC converter.

In addition to one or more of the features described above, or as an alternative to any of the foregoing embodiments, the switch controls the active duty cycle, and the second diode controls the passive duty cycle.

According to another non-limiting embodiment, a dual output buck direct current-to-direct current (DC/DC) converter comprises a switch and a pulsed DC voltage source. The switch includes a PWM input connected to a positive voltage rail to receive a positive DC voltage and a PWM output connected to a switching node. The pulsed DC voltage source is configured to deliver a PWM signal to the switch to continuously operate the switch between a conductive state and a non-conductive state. The dual output buck direct DC/DC converter further includes a positive voltage output circuit and a negative voltage output circuit. The positive voltage output circuit is connected across the switching node and a negative voltage rail configured to receive a negative DC voltage. The positive voltage output circuit is configured to conduct current in a first direction during a first duty cycle to generate a positive output voltage. The negative voltage output circuit is connected across the switching node and the negative voltage rail. The negative voltage output circuit is configured to conduct current in a second direction during a second duty cycle to generate a negative output voltage.

In addition to one or more of the features described above, or as an alternative to any of the foregoing embodiments, the first direction is from the positive voltage rail and through the positive voltage output circuit, and the second direction is from the negative voltage rail through the negative voltage output circuit.

In addition to one or more of the features described above, or as an alternative to any of the foregoing embodiments, the positive voltage output circuit comprises: an inductor having a first terminal electrically connected to the switching node; a capacitor having a first terminal connected to an opposing second terminal of the inductor to establish a positive voltage node, and having an opposing second terminal connected to the negative voltage rail; and a positive voltage load having a first terminal connected to the positive voltage node and an opposing second terminal connected to the negative voltage rail, wherein the current flowing in the first direction flows through the positive voltage load to establish the positive output voltage at the positive voltage node.

In addition to one or more of the features described above, or as an alternative to any of the foregoing embodiments, the negative voltage output circuit comprises: a capacitor having a first terminal connected to the negative voltage rail; a diode having an anode connected to an opposing second terminal of the capacitor, and having a cathode connected to the switching node; and a negative voltage load having a first terminal connected to the negative voltage rail and an opposing second terminal connected in common with the second terminal of the first capacitor and the anode of the second diode to establish a negative voltage node, wherein the current flowing in the second direction flows through the negative voltage load to establish the negative output voltage at the negative voltage node.

In addition to one or more of the features described above, or as an alternative to any of the foregoing embodiments, the switch controls the first duty cycle, and the diode controls the second duty cycle.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a schematic diagram of a dual output buck DC/DC converter according to a non-limiting embodiment of the present disclosure;

FIGS. 2A and 2B illustrate current flow during operation of the dual output buck DC/DC converter according to a non-limiting embodiment of the present disclosure;

FIG. 3 is a signal diagram illustrating the behavior of various voltage and current signals produced by the dual output buck DC/DC converter shown in FIG. 1 according to a non-limiting embodiment of the present disclosure; and

FIG. 4 is an example Switch-Node waveform produced by the dual output buck DC/DC converter shown in FIG. 1 according to a non-limiting embodiment of the present disclosure.

### DETAILED DESCRIPTION

A wide variety of electrically driven components, such as operational amplifiers (op-amps) for example, require both a positive DC power and a negative DC power to provide the functions for which they are designed. In order to provide the negative DC power, conventional systems implement two separate independent circuits to provide the respective voltage polarities. That is, the system implements a traditional buck converter to provide the positive output voltage and an entirely separate traditional inverting boost converter to provide the negative output voltage. This strategy, however, increases the size, number of components, and the overall cost of the system.

Non-limiting embodiments of the present disclosure provide a single dual output buck DC/DC converter that provides both a positive output voltage and a negative output voltage. Accordingly, a single DC/DC converter can be implemented in a system or electrical application that requires usage of both a positive output voltage and a negative output voltage. In this manner, the size, number of components, and overall cost of the system can be reduced.

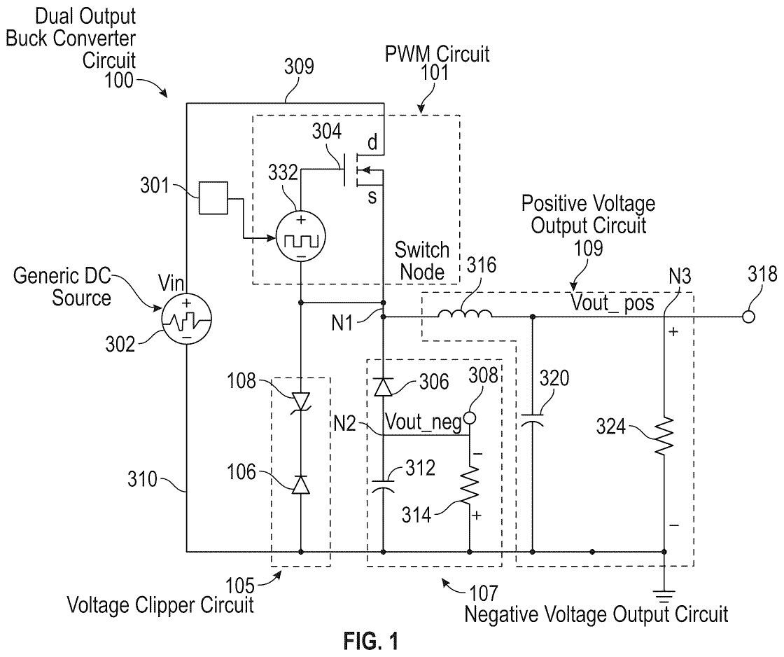

With reference now to FIG. 1, a circuit establishing a dual output buck DC/DC converter 100 is illustrated according to a non-limiting embodiment of the present disclosure. The dual output buck DC/DC converter 100 includes a PWM circuit 101, a voltage clipper circuit 105, a negative voltage output circuit 107, and a positive volage output circuit 109. As described herein, the dual output buck DC/DC converter 100 is capable of utilizing an input DC voltage source 302 to generate both a positive output voltage (Vout_pos) and a negative output voltage (Vout_neg).

The PWM circuit 101 includes a PWM switch 304 and a pulsed DC voltage source 332. In a non-limiting embodiment, the PWM switch 304 is implemented as a transistor such as a metal oxide semiconductor field effect transistor (MOSFET) 304. It should be appreciated, however, that other types of transistors can be utilized to establish the PWM switch 304 without departing from the scope of the invention. The drain of the MOSFET 304 is connected to the positive terminal (+) or positive voltage rail 309 of the input DC voltage source 302 and can serve as a PWM input of the PWM circuit 101. The gate of the MOSFET 304 is electrically connected to the positive terminal (+) of the pulsed DC voltage source 332 and serves a switch control terminal. The source of the MOSFET 304 can serve as the PWM output and is electrically connected in common with the negative terminal (−) of the pulsed DC voltage source 332, the voltage clipper circuit 105, the negative voltage output circuit 107, and the positive voltage output circuit 109 to establish a switching node N1.

The voltage clipper circuit 105 is connected across the MOSFET source (e.g., the PWM output) and the negative voltage rail 310, and is configured to limit the negative voltage swing of the negative voltage pulse generated by the pulsed DC voltage source 332, e.g., applies a limit the lowest negative output voltage that appears at the switching node N1. The voltage clipper circuit 105 includes a first diode 106 and a Zener diode 108. The first diode 106 includes an anode that is electrically connected to ground or a neutral rail 310, which is electrically connected to the negative terminal (−) of the input DC voltage source 302. The cathode of the first diode 106 is electrically connected to the cathode of the Zener diode 108. The anode of the Zener diode 108 is electrically connected to the switching node N1. Accordingly, the Zener diode 108 can serve as a voltage clamping device or establish a voltage clamping circuit. Although a Zener diode 108 is described herein, other types of voltage clamping devices can be implemented including, but not limited to, a TVS diode, a metal oxide varistor (MOV), and a Schottky diode, without departing from the scope of the present disclosure. In a non-limiting embodiment, a stack of one or more diodes (power, signal, Schottky, etc.) in the orientation diode (106) may be implemented with the Zener diode 108 removed.

The negative voltage output circuit 107 is connected in parallel with the voltage clipper circuit 105 and the positive voltage output circuit 109. The negative voltage output circuit 107 includes a first capacitor 312, a second diode 306, and a first resistor 314. A first terminal of the first capacitor 312 is electrically connected to the neutral rail 310, while a second terminal of the first capacitor 312 is electrically connected to the anode of the second diode 306. According to a non-limiting embodiment, the first capacitor 312 is designed at a large enough capacitance to maintain the negative output voltage (Vout_neg) during the off state of the second diode 306.

The cathode of the second diode 306 is electrically connected to the switching node N1, while the connection between the anode of the second diode 306 and the first capacitor 312 establishes a negative voltage node N2. The characteristics of the second diode 306 can be different from the first diode 106, or can be the same, or substantially the same, as the first diode 106. When the characteristics of the second diode 306 the same, or substantially the same as the first diode 106, the voltages appearing thereacross will be substantially the same, and the voltage across the Zener diode 108 will define the value of the negative output voltage (Vout_neg) appearing at the negative voltage node N2.

A first terminal of the first resistor 314 is electrically connected to the neutral rail 310. The opposing second terminal of the first resistor 314 serves as the negative voltage terminal 308 that provides the negative output voltage (Vout_neg) of the dual output buck DC/DC converter 100, while the negative output current (Iout_neg) flows through the first resistor 314. In the example circuit, the first resistor 314 represents a negative voltage load, and could be replaced by any circuitry or “load” device that realizes a negative voltage applied thereacross.

The positive voltage output circuit 109 is connected in parallel with the with the voltage clipper circuit 105 and the negative voltage output circuit 107. The positive voltage output circuit 109 includes an inductor 316, a second capacitor 320, and a second resistor 324. Although a single capacitor 320 is shown in the positive voltage output circuit 109, it should be appreciated that additional capacitors can be implemented without departing from the scope of the invention.

The inductor 316 includes a first terminal electrically connected to the switching node N1. The second terminal of the inductor 316 is electrically connected in common with a first terminal of the second capacitor 320 and a first terminal of the second resistor 324 to establish a positive voltage node N3. In the example circuit, the second resistor 324 represents a positive voltage load, and could be replaced by any circuitry or “load” device that realizes a voltage applied thereacross. The second terminals of the second capacitor 320 and the second resistor 324 are electrically connected to the positive voltage node N3. The positive voltage node N3 serves as the positive voltage terminal 318 that provide the positive output voltage (Vout_pos) of the dual output buck DC/DC converter 100, while the positive output current (Iout_pos) flows through the second resistor 324. The inductor 316 filters the positive output current (Iout_pos) and the second capacitor 320 filters the positive output voltage (Vout_pos).

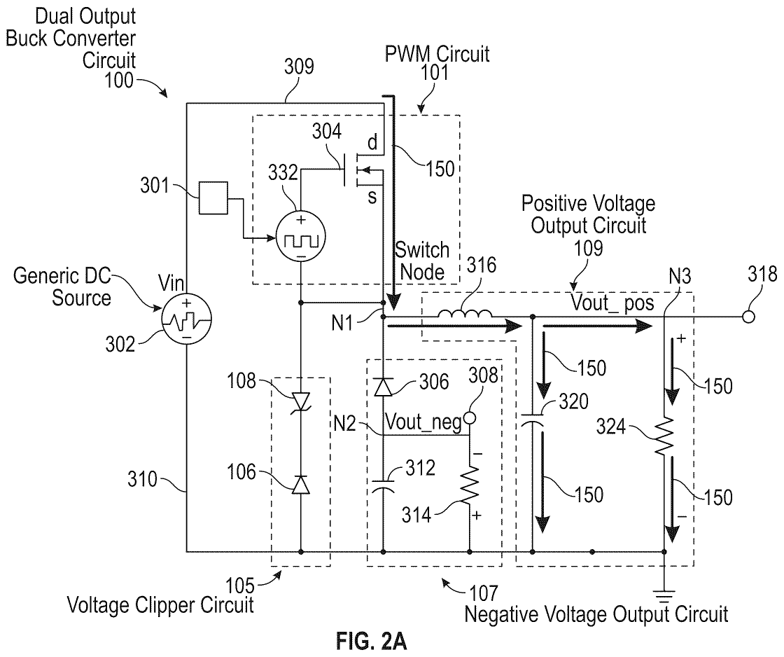

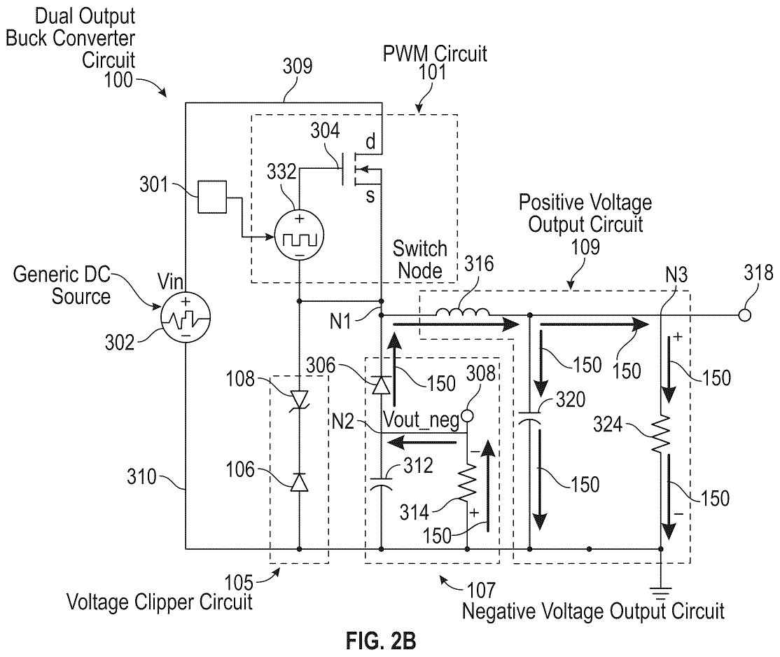

The high/low states of the pulsed DC voltage source 332 are controlled by a controller 301 according to any known control scheme. The switching of the pulsed DC voltage source 332 defines an active first duty cycle that is controlled by actively switching on and off the MOSFET 304 via the pulsed DC voltage source 332. As described above, current (indicated as arrows 150) flows from the positive voltage rail 309, through the inductor 316 and to the negative voltage rail 310 via the second resistor 324 to establish a positive output voltage (Vout_pos) (see FIG. 2A)

A second duty cycle is defined via the interaction between the negative pulsed voltage and the second diode 306, i.e., the passive conduction of the second diode. Since the MOSFET gate is at 0V during the non-conductive state, it turns OFF. The current (indicated as arrows 150), however, continues to flow through the inductor 316, thereby establishing a voltage negative at the switching node N1 (see FIG. 2B). That is, current does not “stop” flowing through the inductor 316, but instead continues to flow thereby “pulling” the voltage negative at the switching node N1.

During second duty cycle, the voltage clipper circuit 105 clamps the voltage potential at a set voltage level (e.g., clamped at a set negative volage), and the second diode 306 is forward-biased (i.e., conducts) to establish a current path through from the negative voltage rail 310, through the first resistor 314 and to the inductor 316. The negative voltage appearing at the switching node N1 is maintained during the positive duty cycle by capacitor 312. As a result, the second diode 306 conducts the current and allows stored energy from the circuit to induce current flow through the negative voltage node N2 and causing a negative output voltage (Vout_neg) to appear at the negative voltage terminal 308. Accordingly, the second duty cycle is passive according to current conduction induced by the voltage differential between the neutral rail 310 and the switching node N1.

During operation, the dual output buck converter circuit 100 generates both a regulated positive output voltage (Vout_pos) and a regulated negative output voltage (Vout_neg) using a single input DC voltage source 302. The input DC voltage source 302 supplies a positive input voltage (+Vin) to the positive voltage rail 309 and a negative input voltage (−Vin) to the negative voltage rail 310. The controller 301 controls the pulsed DC voltage source 332 to generate a pulse-width modulation (PWM) signal, which include positive voltage pulses and negative voltage pulses. The PWM signal controls the switching (e.g., on state and off state) of the field-effect transistor (FET) 304, which acts as a switch. The switching node (N1) serves as a connection point where energy transfer is regulated, based on the state (e.g., conducting state or non-conducting state) of MOSFET 304.

Switching the on state and off state of the MOSFET 304 controls the flow of energy in the dual output buck converter circuit 100. When the MOSFET 304 turns ON, as shown in FIG. 2A, current flows from the positive voltage rail 309 (e.g., +5V) through inductor 316, allowing it to store energy in its magnetic field. At the same time, current does not flow through diode 306 because it is reverse-biased, preventing energy transfer to the negative voltage output circuit 107. During this phase, current flows to the negative voltage rail 310 via capacitor 312 and resistor second resistor 324 to provide the regulated positive output voltage (Vout_pos). When the MOSFET 304 turns OFF, as shown in FIG. 2B, the stored energy in inductor 316 decays, while inducing current to flow from the negative voltage rail 310 through the first resistor 314. At the same time, the second diode 306 becomes forward-biased, allowing current to flow into the inductor 316 and transferring energy to the negative output capacitor 312. This ensures that the negative voltage node N2 receives the necessary voltage to maintain a regulated negative output voltage (Vout_neg) across the first resistor 314, which also appears at the negative voltage terminal 308.

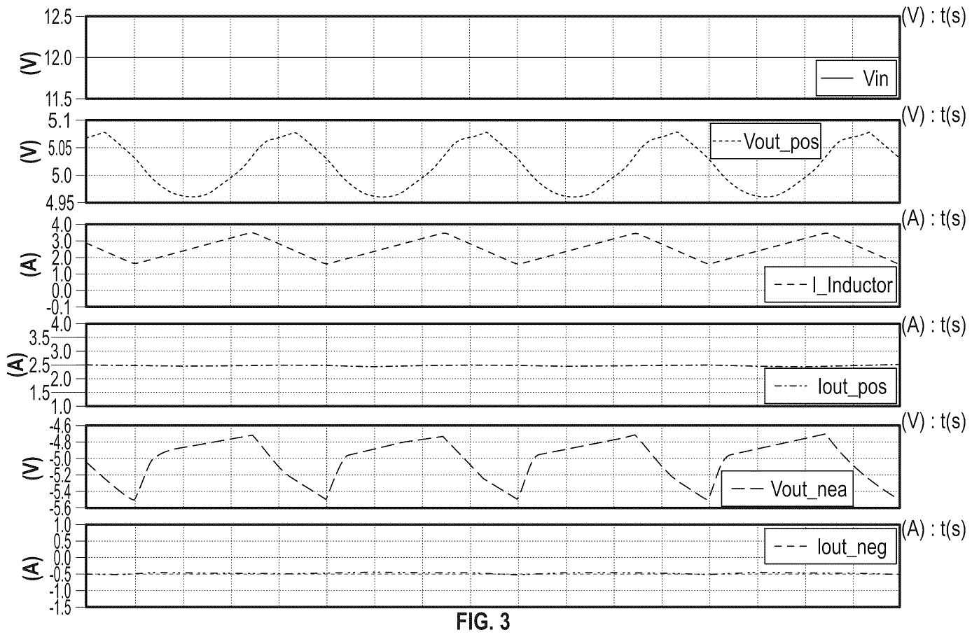

The positive pulsed voltage generated by the pulsed DC voltage source 332 controls the first duty cycle defined by switching the on state/off state of the MOSFET 304. In a non-limiting embodiment, a gate resistor (not shown) can be electrically connected between the gate of the MOSFET 304 and the pulsed DC voltage source 332 to limit current in and out of the MOSFET 304. The negative pulsed voltage generated by the pulsed DC voltage source 332 controls the second duty cycle defined by the second diode 306. An example signal diagram illustrating the behavior of various voltage and current signals produced by the dual output buck DC/DC converter 100 is illustrated in FIG. 3. It should be appreciated that the dual output buck DC/DC converter 100 is not limited to the example voltages and currents depicted in FIG. 2.

As described herein, the input voltage (Vin) delivered by the input DC voltage source 302 is converted into a positive output voltage (Vout_pos) that appears at the positive voltage terminal 318 and a negative output voltage (Vout_neg) that appears at the negative voltage terminal 308. Accordingly, the positive output voltage (Vout_pos) and the negative output voltage (Vout_neg) can be generally defined as:

Vout_pos=(Vin*D1)−(Vout_neg*D2);

Vout_neg=−((Vin*D2)−(Vout_pos*D1),

where D1 is the first duty cycle and D2 is the second duty cycle.

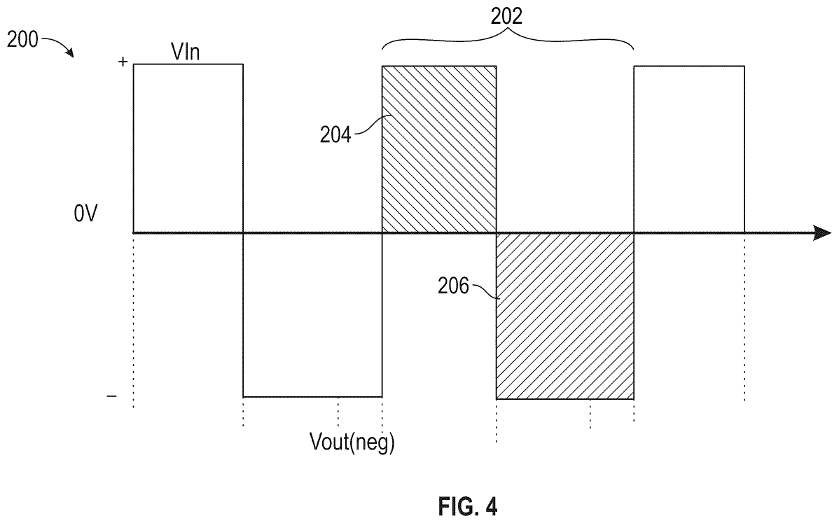

As described herein, the dual output buck DC/DC converter 100 operates according to two duty cycles, where D1 is a duty cycle of established by the switching state of the MOSFET 304 and D2 is the duty cycle established by the second diode 306. FIG. 4 illustrates an example Switch-Node waveform 200 appearing at the switching node N1 of the dual output buck DC/DC converter 100 (see FIG. 1), where “Vin” is the input voltage provided by the input DC voltage source 302, “Vout_neg” is the negative output voltage appearing at the negative voltage terminal 308, and “Is” is the current flowing through the inductor 316.

The dual output buck DC/DC converter 100 produces a negative voltage (−V) to positive voltage (+) wave 200. The wave 200 can behave as a square wave 200, for example, having an example period 202, which feeds an inductance/capacitance (LC) filter established by the inductor 316 and the second capacitors 320. The square wave 200 defines a first area 204 during a time where the square wave 200 is above 0 (+V), and a second area 206 during a time where the square wave 200 is below 0V (−V).

The time at negative voltage (the second area 206 where the square wave 200 is below 0V) takes away from the first area 204 of positive voltage, and the total duty cycle of the square wave 200 is the combined time of the first area 204 above 0 V and the second area 206 below 0V. The second area 206 below 0V necessary to provide the negative voltage terminal 308. As a result, the first duty cycle (D1) established by the MOSFET 304 is increased to compensate for the second area 206 (i.e., the negative area). The second area 206 below 0V may occur at any portion of the square wave 200, provided the second area 206 below 0V does not overlap with the first area 204 above 0V.

As described herein, a dual output buck DC/DC converter is provided, which outputs both a positive output voltage and a negative output voltage. Accordingly, a single DC/DC converter can be implemented in a system or electrical application that requires usage of both a positive output voltage and a negative output voltage. In this manner, the size, number of components, and overall cost of the system can be reduced.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. A dual output buck direct current-to-direct current (DC/DC) converter comprising:
a positive voltage rail configured to receive a positive DC voltage from a DC power source, and a negative voltage rail configured to receive a negative DC voltage from the DC power source;
a switch including a PWM input connected to the positive voltage rail and a PWM output connected to a switching node;
a pulsed DC voltage source configured to deliver a PWM signal to the switch;
a positive voltage output circuit connected across the switching node and the negative voltage rail, the positive voltage output circuit configured to conduct current from the positive voltage rail in a first direction to generate a positive output voltage in response to the switch operating in conducting state; and
a negative voltage output circuit connected across the switching node and the negative voltage rail, the negative voltage output circuit configured to conduct current from the negative voltage rail in a second direction to generate a negative output voltage in response to the switch operating in a non-conductive state.

2. The dual output buck DC/DC converter of claim 1, further comprising a voltage clipper circuit connected across the switching node and the negative voltage rail.

3. The dual output buck DC/DC converter of claim 2, wherein the voltage clipper circuit comprises:
a first diode having an anode connected to the negative voltage rail; and
a voltage clamping device including a first terminal connected to a cathode of the first diode, and including an opposing second terminal connected to the switching node.

4. The dual output buck DC/DC converter of claim 3, wherein the voltage clamping device includes a Zener diode having a cathode connected to a cathode of the first diode and having an anode connected to the switching node.

5. The dual output buck DC/DC converter of claim 4, wherein the negative voltage output circuit comprises:
a first capacitor having a first terminal connected to the negative voltage rail;
a second diode having an anode connected to an opposing second terminal of the first capacitor, and having a cathode connected to the switching node; and
a negative voltage load having a first terminal connected to the negative voltage rail and an opposing second terminal connected in common with the second terminal of the first capacitor and the anode of the second diode to establish a negative voltage node configured to deliver the negative output voltage.

6. The dual output buck DC/DC converter of claim 5, wherein the positive voltage output circuit comprises:
an inductor having a first terminal electrically connected to the switching node;
a second capacitor having a first terminal connected to an opposing second terminal of the inductor to establish a positive voltage node, and having an opposing second terminal connected to the negative voltage rail; and
a positive voltage load having a first terminal connected to the positive voltage node and an opposing second terminal connected to the negative voltage rail,
wherein the positive voltage node is configured to deliver the positive output voltage.

7. The dual output buck DC/DC converter of claim 6, wherein the PWM circuit comprises:
the switch connected between the positive voltage rail and the switching node; and
the pulsed DC voltage source including a negative output connected the switching node to deliver negative voltage pulses, and a positive output connected to the switch to deliver positive voltage pulses that control a switching state of the switch.

8. The dual output buck DC/DC converter of claim 7, wherein the switch includes a metal oxide semiconductor field effect transistor (MOSFET) comprising:
a drain serving as the PWM input connected to the positive voltage rail;
a gate connected to the positive output of the pulsed DC voltage source; and
a source serving as the PWM output connected to the switching node.

9. The dual output buck DC/DC converter of claim 7, wherein the negative output voltage is generated during a passive duty cycle of the dual output buck DC/DC converter, and the positive output voltage is generated during an active duty cycle of the dual output buck DC/DC converter.

10. The dual output buck DC/DC converter of claim 9, wherein the switch controls the active duty cycle, and the second diode controls the passive duty cycle.

11. A dual output buck direct current-to-direct current (DC/DC) converter comprising:
a switch including a PWM input connected to a positive voltage rail to receive a positive DC voltage and including a PWM output connected to a switching node;
a pulsed DC voltage source configured to deliver a PWM signal to the switch to continuously operate the switch between a conductive state and a non-conductive state;
a positive voltage output circuit connected across the switching node and a negative voltage rail configured to receive a negative DC voltage, the positive voltage output circuit configured to conduct current in a first direction during a first duty cycle to generate a positive output voltage; and
a negative voltage output circuit connected across the switching node and the negative voltage rail, the negative voltage output circuit configured to conduct current in a second direction during a second duty cycle to generate a negative output voltage.

12. The dual output buck DC/DC converter of claim 11, wherein the first direction is from the positive voltage rail and through the positive voltage output circuit, and the second direction is from the negative voltage rail through the negative voltage output circuit.

13. The dual output buck DC/DC converter of claim 12, wherein the positive voltage output circuit comprises:
an inductor having a first terminal electrically connected to the switching node;
a capacitor having a first terminal connected to an opposing second terminal of the inductor to establish a positive voltage node, and having an opposing second terminal connected to the negative voltage rail; and
a positive voltage load having a first terminal connected to the positive voltage node and an opposing second terminal connected to the negative voltage rail,
wherein the current flowing in the first direction flows through the positive voltage load to establish the positive output voltage at the positive voltage node.

14. The dual output buck DC/DC converter of claim 13, wherein the negative voltage output circuit comprises:
a capacitor having a first terminal connected to the negative voltage rail;
a diode having an anode connected to an opposing second terminal of the capacitor, and having a cathode connected to the switching node; and
a negative voltage load having a first terminal connected to the negative voltage rail and an opposing second terminal connected in common with the second terminal of the first capacitor and the anode of the second diode to establish a negative voltage node,
wherein the current flowing in the second direction flows through the negative voltage load to establish the negative output voltage at the negative voltage node.

15. The dual output buck DC/DC converter of claim 14, wherein the switch controls the first duty cycle, and the diode controls the second duty cycle.
